(19) United States
(12) Patent Application Publication
(10) Pub. No.: US 2026/0310632 A1
(43) Pub. Date: Oct. 8, 2026

(54) METHODS AND SYSTEMS CONFIGURED TO ELIMINATE THE USE OF WRITE AHEAD LOGS IN PAGED DIRECT MAPPING KEY-VALUE STORES

(71) Applicant: QiStor Inc., San Jose, CA (US)

(72) Inventor: Andrew John TOMLIN, San Jose, CA (US)

(73) Assignee: QiStor Inc., San Jose, CA (US)

(21) Appl. No.: 19/481,707

(22) PCT Filed: Aug. 6, 2024
(86) PCT No.: PCT/US2024/041093

§ 371 Date: Nov. 5, 2025

Related U.S. Application Data
(60) Provisional application No. 63/578,513, filed on Aug. 24, 2023.

(51) Int. Cl. G06F 16/18; G06F 16/215

(52) U.S. Cl. CPC G06F 16/1865; G06F 16/215

(57) ABSTRACT

A computer-implemented method of implementing a multi-command transaction in a key-value store includes receiving the transaction that includes a list of keys and separate commands and value data for each of the keys. A TransactionLogPage may be written to media, with an AtomicTransactionTag assigned to the transaction, a count of the keys, the keys, and atomic metadata corresponding to each of the keys. An AtomicKeyTag may be assigned to each of the keys, each associated with an original value and a pending value and each AtomicKeyTag may be encoded as a location in the media. A command corresponding to each of the keys may be received to write the value data as the pending value corresponding to each of the AtomicKeyTags to the media along with a header identifying the AtomicTransactionTag. Atomic metadata may be updated and temporarily stored for each of the written pending values. When an Abort is detected indicating that the transaction has failed or has been interrupted, the TransactionLogPage may be rewritten as an AbortTransactionLogPage that identifies the failed AtomicTransactionTag and the original metadata may be restored to the metadata mapping system. Alternatively, when all value data has been written for each AtomicKeyTag and the atomic metadata for each of the written pending values has been updated and temporarily stored, the metadata mapping system may be updated using the atomic metadata.

### BACKGROUND

Disk and flash storage devices such as Hard Disk Drives and Solid-State Drives provide block-based storage via their interfaces. As shown in FIG. 1A, block-based storage devices have standardized logical interfaces to map fixed-size blocks 102, typically 512 bytes or 4096 bytes of data, to a logical block address (LBA) 104. Examples of these interfaces include NVMe, SATA and SCSI.

One of the Key challenges in storage systems is that real-world data often does not neatly fit into the fixed-size logical blocks provided by such block-based storage devices. To address this, systems implement additional hierarchical mapping mechanisms in software, enabling efficient storage of real-world data that can have a size granularity down to 1 byte.

A common storage mapping interface abstraction that is used to map variable-sized pieces of user data is known as Key-Value, as shown in FIG. 1B. This abstraction provides an application-friendly interface to the storage system by associating each piece of data (the Value) 108 with a unique identifier (the Key) 106, a user-defined reference. As the Key 106 is user-defined, it is an abstraction that does not rely on the physical location of the data, which is a problem delegated to lower levels. In this system, the user supplies both the Key 106 and the Value data 108 for storage operations, while for retrieval operations, the user provides the Key 106, and the system returns the corresponding Value data 108. This Key-Value mapping allows for rapid and efficient data access, as the Key 106 directly links to the Value data 108. The simplicity and versatility of Key-Value stores enable them to handle a wide variety of data types, making Key-Value stores particularly suitable for scalable and adaptable data management solutions. These characteristics render Key-Value stores a fundamental component in contemporary data storage and retrieval systems, providing significant performance benefits and operational efficiency.

To further contrast LBA and Key-Value, the LBA 104 is a device-supplied reference to a fixed-size block 102 in a linear address space 105, while Key-Value is a user-supplied reference to a variable-sized block of data. The Key 106 is a number of user-defined bytes of user-defined length (up to a maximum number), and importantly, unlike an LBA-style mapping system, the Key 106 does not necessarily reference a contiguous set of addresses.

While convenient for applications, Key-Value mapping systems present several implementation challenges that simple LBA mapping schemes do not. These include:
the Key is not fixed in size;
the Key is user-defined;
the mapping space is not contiguous;
the Value is variable sized, and
a variable number of Key-Value data may exist in a predetermined storage capacity.

Any Key-Value mapping system must address these issues. Most solutions use hierarchical mapping systems, hash tables, tree structures, and other algorithms to track the location and enable the retrieval of Value data. The solutions space is much simpler if all the mapping data can fit into memory. For many solutions, however, not all the mapping information can be fitted into memory, so it must be paged in and out, which incurs a time penalty.

### BRIEF DESCRIPTION OF THE DRAWINGS

FIG. 1A is a diagram of a conventional logical block address based data storage system.

FIG. 1B is a representation of a Key-Value store system.

FIG. 2 shows a basic diagram of a paged direct mapping Key-Value store that may be configured according to embodiments.

FIG. 3 is a block diagram illustrating a Key-Value store implementing a conventional Log Structure Merge (LSM) system.

FIG. 4 shows a multi-command transaction.

FIG. 5 is a block diagram illustrating a transaction define sequence.

FIG. 6 is a block diagram showing a duplicate Key detector, according to embodiments.

FIG. 7 is a representation of a TransactionLogPage, according to embodiments.

FIG. 8 shows the state of the media after the initial TransactionLogPage write, according to embodiments.

FIG. 9 shows the logical relationship between the AtomicTransactionTag, the AtomicKeyTag and the UserKeys, according to embodiments.

FIG. 10 is a diagram illustrating the one-to-one mapping of a UserKey to Value data.

FIG. 11 shows a manner in which a UserKey may be mapped to both an original Value (before execution of the multi-command transaction) and a pending Value (after execution of the multi-command transaction), according to embodiments.

FIG. 12 shows the manner in which the UserKey corresponds to an AtomicKeyTag, which may be encoded as a Location pointing to both the original Value and the pending Value, according to embodiments.

FIG. 13 shows the structure of one possible implementation of an AtomicTransactionTag table and an AtomicKeyTag table, according to an embodiments.

FIG. 14 shows an incomplete TransactionLogPage stored in media, according to embodiments.

FIG. 15 shows a complete TransactionLogPage stored in media, according to embodiments.

FIG. 16 is a flowchart of a computer-implemented method of processing a multi-command transaction in a Key-Value store, including the processing that occurs when an Abort is detected, according to embodiments.

FIG. 17 is a flowchart of a computer-implemented method of power fail recovery in a Key-Value store according to embodiments.

FIG. 18 is a flowchart of a computer-implemented method of implementing a multi-command transaction in a Key-Value store, according to embodiments.

FIG. 19 is a computer-implemented method of recovering from a power failure in a Key-Value store implementing a multi-command transaction, according to embodiments.

FIG. 20 is a block diagram of a computer system with which aspects of the embodiments described herein may be practiced.

### DETAILED DESCRIPTION

FIG. 2 shows a system in which a storage device (also referred to herein as “media”) 202 stores a full set of mapping metadata 204 and user data 206. The full mapping metadata 204 may be significantly larger than the portion 210 of mapping metadata that can fit in memory 208. As the full mapping metadata 204 may be too large to load in its entirety in the memory 208, only a portion 210 of the full mapping metadata 204 may be paged into the memory 208. Indeed, in a paged mapped Key-Value storage system, metadata mapping information must be stored and retrieved (paged in and out) between memory 208 and storage devices 202 during normal operation.

One significant difference between managing fixed-sized blocks in regular storage and Key-Value storage is that the number of objects contained within a Key-Value store is variable. This means that the metadata storage system must also grow in proportion to the number of stored objects and thus must be dynamic in size.

In any solution where searching is avoided (i.e., retrieval of a piece of data from the Key-Value store requires only one read of metadata and one read of the Value to the media), there should be a guarantee that there exists a unique piece of metadata mapping information for each Key. This unique metadata mapping information can avoid more than two reads while retrieving data to find the most up-to-date Key-Value. However, the amount of metadata mapping information in this case is much bigger and can be an issue. In such a system, however, it is guaranteed that a maximum of one read will page in the correct metadata mapping data, and that only one read need be performed to access the Value data referenced by the Key.

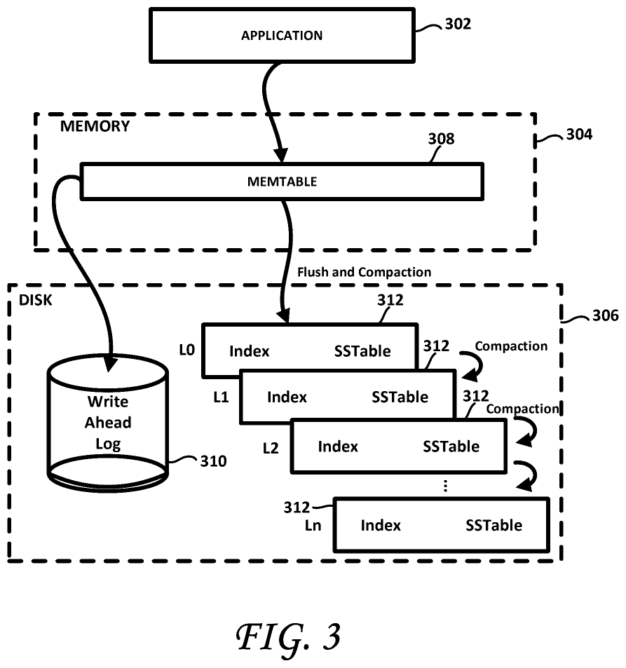

The size of the metadata mapping information becomes a critical problem for a metadata mapping system suitable for managing Key-Value data. There is a tradeoff between the accuracy of location information and the need for searching. Current state-of-the-art solutions include Log Structure Merge (LSM), in which location information may be highly abstracted, most often requiring multiple reads and search operations to locate the Value data, including potentially stale copies thereof. Solutions like LSM can result in more than two reads, and those reads can be much larger than the Value data of interest. As a consequence and in direct contrast, the embodiments described, shown, and claimed herein enable up to a 10× benefit in terms of power and performance over LSM based solutions. FIG. 3 is a block diagram of an LSM system utilizing a Write Ahead Log. Conceptually and as shown in FIG. 3, an LSM system may include an Application 302 that issues write and read commands, Memory (e.g., Random Access Memory or RAM) 304 and persistent storage (e.g., a disk including rotating media and/or a solid state device such as Flash memory) 306. The memory 304 stores a Memtable 308, which is an in-memory table that enables fast write operations. Immediately after the Key-Value is stored in the Memtable 308, it is also stored in a Write Ahead Log (WAL) 310 that is maintained in the disk 306. The WAL 310 is a persistent log for all changes and to enable reconstruction of the data in case of a power cycle or other system failure. As the Memtable 308 fills up, it is periodically flushed and compacted into Sorted String Tables (SSTables) 312 on disk. The SSTables 312 are organized into layers (L0 through Ln), with each successive layer being larger than the previous layer. When a read command is received from Application 302, the LSM tree first checks the Memtable 308. If the desired data is present in the Memtable, it may be provided quickly. If the data of interest is no longer located in the Memtable 308 but has since been flushed to the SSTables 312 on disk 306, the LSM tree goes to disk 306 and uses a so-called Bloom Filter to repeatedly search the indices to determine a probability that the data of interest is located in one of the n SSTables 312, starting at L0 and moving down as needed. After determining that the Value data is likely to be present in a particular one of the SSTables, the LSM tree searches that table and if the data of interest is present therein, returns the value.

One common application of Key-Value storage is for database applications. Key-Value is commonly used as the storage engine layer in these databases and other similar applications. In these applications, it is desirable to be able to atomically write multiple separate Key-Value pairs at the same time, as a single transaction.

One example that illustrates the need to atomically write multiple separate Key-Value pairs at the same time is in the database use case, where two separate records need to be updated together and are contained in different Key-Value pairs. If there needs to be a guarantee that either both records are updated, or no records are updated, then some kind of transaction mechanism is required. The standard methodology to perform this kind of operation uses a Write-Ahead Log, such as shown at 310 in FIG. 3. A Write-Ahead Log writes the transaction into a temporary location before updating the actual records as a transaction. In the event of a power cycle, the Write-Ahead Log 310, if complete, can be accessed to complete the transaction. If the Write-Ahead Log 310 is not complete, then it is discarded, and the original data is left unaltered. The main issue with this scheme is that it requires writing the data twice, once to the WAL 310 and another time to the media proper (such as to the SSTables 312). This Write Amplification impacts performance and wear of the media. It should be noted that the embodiments disclosed herein are intended to ensure write coherency of the transaction, and not any database level read vs. write consistency.

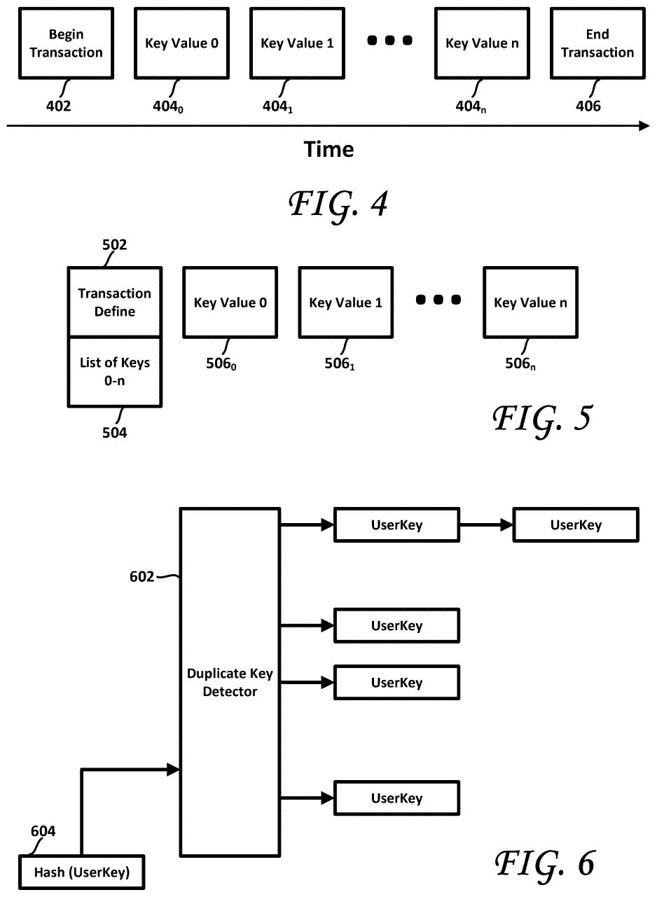

The embodiments disclosed herein include methods and systems configured to eliminate the use of Write-Ahead Logs in paged direct mapping key-value stores. FIG. 4 is a block diagram illustrating a generic transaction sequence that is independent of interface or Application Program Interface (API) semantics. For simplicity, it is assumed that each Key-Value pair is stored as a result of a separate command, as is common in most interfaces. The beginning of a transaction is indicated by a command 402, whereupon a number of Key-Value pairs 404₀-404ₙ are written associated with the transaction. Following the last key write command, an End Transaction 406 is indicated. Note that beginning and ending transaction operations 402, 406 may be performed in multiple ways, either through separate commands or a Transaction Define command, which may specify the all of the Keys associated with the entire transaction.

FIG. 5 is a block diagram illustrating a transaction define sequence. As shown, a transaction define sequence is a sequence comprising a Transaction Define command 502 and a List of Keys 0-n 504 to be handled atomically provided at the beginning of the sequence. The Transaction Define 502 and the List of Keys 504 is then followed by a plurality of Key-Value pairs 506₀ to 506ₙ. The Transaction Define command is considered completed when the storage of all Keys 0-n are acknowledged, or via completion of the Transaction Define command 502 depending on interface semantics.

The embodiments disclosed herein may be readily applied to both the basic transaction scheme shown in FIG. 4 and the Transaction Define sequence shown in FIG. 5. This application, however, focusses on the Transaction Define sequence of FIG. 5, it being understood that embodiments are not limited thereto.

In the Transaction Define sequence, the storage device receives a List of keys, as shown at reference 504 in FIG. 5. According to an embodiment, this List of Keys 504 is allocated a tag, which may be called an AtomicTransactionTag. The AtomicTransactionTag may be used to manage the life cycle of the multi command operation. The List of Keys 504 may be stored in a Hash table 602 called a Duplicate Key Detector. The Hash table 602 is a table with linked lists for collisions that is easily searchable. As shown in FIG. 6, a hash 604 of a provided UserKey is generated, which may be used to index into the Hash table 602 to determine whether the Hash table 602 stores a matching UserKey. The Duplicate Key Detector functionality of FIG. 6 is primarily a mechanism to detect host error, potentially from independent hosts, such as multiple writes of the same Key that would otherwise result in incorrect count of updates and identification of transaction completion. According to one embodiment, the Hash table 602 may be consulted for a match for every command entering the device to detect Key overlaps. Note that other implementations are possible, such as red/black tree, AVL tree, or a brute force search. An alternate implementation can forgo this duplicate check and still guarantee the transaction, as the embodiments disclosed herein can still guarantee the atomicity. However, the structure and functionality of FIG. 6 is an implementation that is configured to quickly detect and return errors to the host.

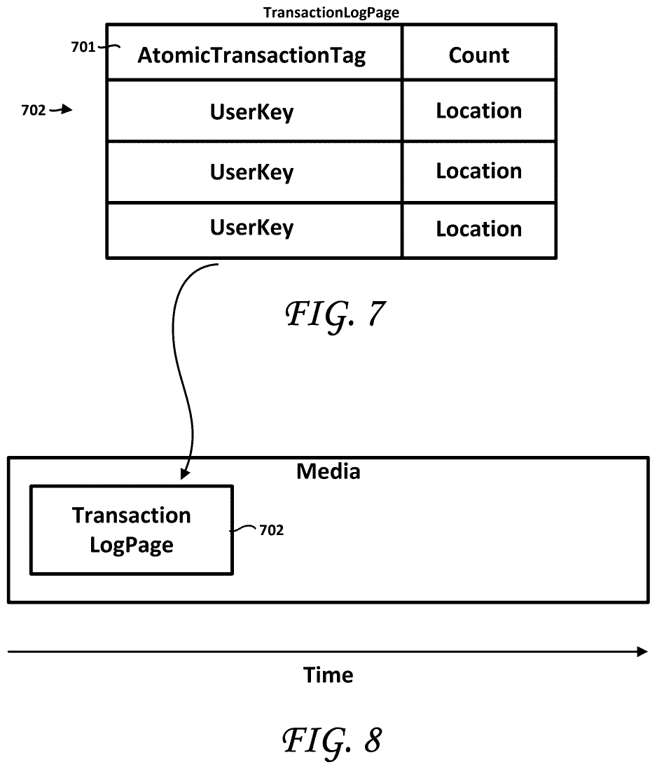

As shown in FIGS. 7 and 8, the AtomicTransactionTag 701 assigned to the List of Keys 504 and each UserKey and Atomic Metadata of the multi-command transaction is also written to the media in a TransactionLogPage 702 at this time to allow the detection of various cases and recovery in event of power cycle. The TransactionLogPage 702, according to an embodiment, may be configured to provide a running record of the multi-command transaction as it executes or, in the case of a power fail recovery, as the multi-command transaction was executed, either partially or to completion. The TransactionLogPage 702, as shown in FIG. 7, may include an AtomicTransactionTag 701. A Count field in the TransactionLogPage 702 indicates the number of UserKeys present in the TransactionLogPage 702. As shown in FIG. 7, each TransactionLogPage includes a list of the 0-n UserKeys in the Transaction Define sequence, each being associated with Atomic Metadata. FIG. 8 shows the state of the media immediately after the initial TransactionLogPage Write and before any Value data corresponding to the UserKeys has been written. Note that the Atomic Metadata information associated with each UserKey in the TransactionLogPage 702 is marked as “Invalid” in this initial write.

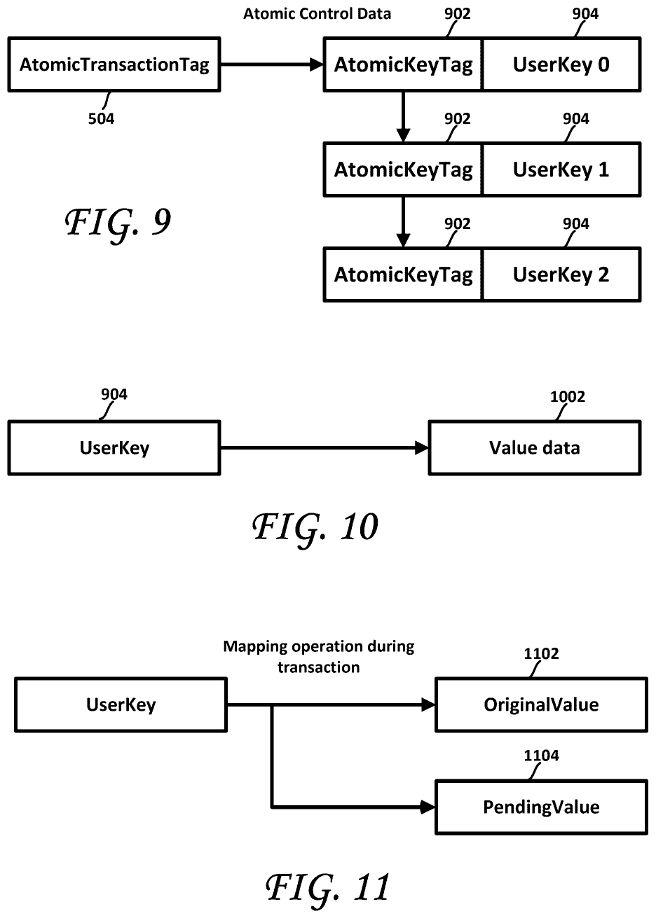

FIG. 9 shows the logical relationship between the AtomicTransactionTag, the AtomicKeyTag and the UserKeys. As shown, each UserKey 904 in the list of Keys 0-n (n=2 in FIG. 9) of the multi-command operation identified by the AtomicTransactionTag 504 is allocated an AtomicKeyTag 902. The AtomicKeyTags 902 may be allocated at the beginning of the transaction, or the AtomicKeyTag may be allocated upon arrival of the actual UserKey.

According to an embodiment, the AtomicKeyTag 902 may be encoded in the system as a special location within a predetermined portion of the media address range. That is, for a small number of locations at, for example, the end of the media address range, instead of the location corresponding to a physical location, the location is instead interpreted as an AtomicKeyTag corresponding to a UserKey. Significantly, as the AtomicKeyTag 902 is handled in a similar fashion as location, it can be handled as a regular location update for most of the system. An alternate embodiment may be configuring other parts of the Atomic Metadata, including a flag or other unique and otherwise illegal metadata configurations to indicate that the metadata refers to an AtomicKeyTag 902. A significant element is that the system, when accessing the metadata, can determine that it is an in-process transaction and redirect to the appropriate control information.

The Key-Value metadata mapping system is designed to manage the one-to-one mapping of Keys to locations. Indeed, such a metadata mapping system relies on the concept that for every Key there is a unique item of metadata that indicates the size and location of the data. In a paged system, the metadata page where the metadata corresponding to a Key of interest is specified is often not present in Random Access Memory (RAM) but is stored on media and must be identified and paged into memory. The primary purpose of the Key-Value metadata mapping system for normal operation is, therefore, to manage this one-to-one mapping of a UserKey to Value data 1002, as shown in FIG. 10.

The primary challenge of managing the transaction is that during the transaction process, there are two versions of the Value data corresponding to a UserKey: the original Value 1102 and the new pending Value 1104, as shown in FIG. 11. Herein, the new pending Value 1104 is the Value data after the transaction, assuming the transaction or this portion of the transaction completes. According to embodiments, there can be no assumptions on which Value (original or pending) will ultimately be valid until the transaction define completes or fails in its entirety. This must hold true even in the event of a power cycle.

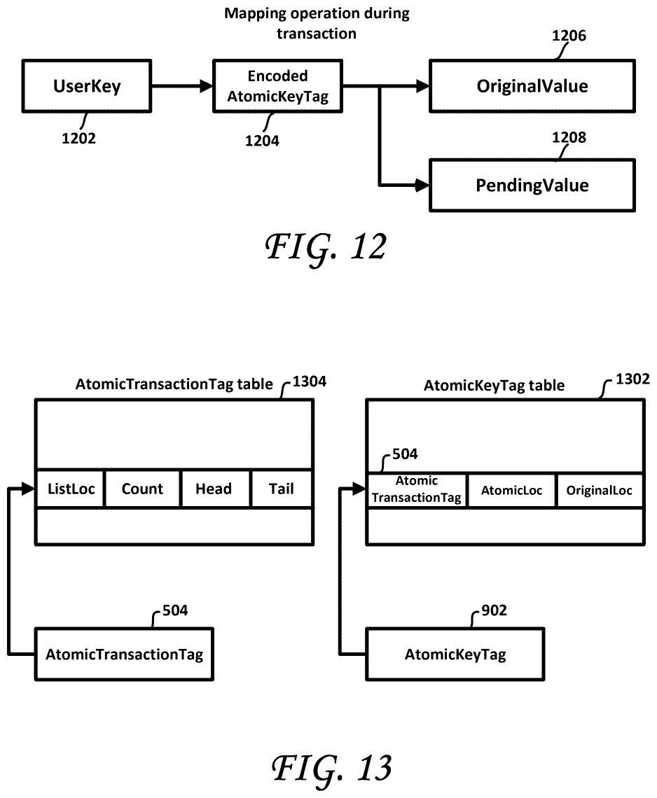

As shown in FIG. 12 and according to an embodiment, for the UserKeys 1202 that are part of a multi-command transaction, the AtomicKeyTag may be encoded into a media location (thereby generating the Encoded AtomicKeyTag 1204), which replaces the actual metadata tracked by the Key-Value metadata mapping system to enable an additional level of indirection. Significantly, this indirection allows the management of two metadata items, one metadata item storing the original Value metadata (the OriginalValue 1206) prior to the transaction or after the failure of the transaction and the other item storing the pending Value metadata (the PendingValue 1208) as it would be after the transaction, assuming the transaction completes. In this manner, the details of the additional indirection can be hidden from most of the metadata mapping system, as being referenced simply as the Encoded AtomicKeyTag, which is treated by the metadata mapping system as a location, thereby simplifying the overall complexity.

Recall that the metadata management system manages the one-to-one mapping of Keys to location and size metadata. The location may be specified using n-bits, and the size may be specified using m-bits. Provided the metadata is not written to media, the n location bits and m size bits can be used, according to embodiments, for purposes other than indicating location and size metadata. In one implementation, a size value that exceeds a predetermined maximum allowable size may be re-interpreted as a flag that indicates that the n location bits should be interpreted not as a location but as the AtomicKeyTag 902. In another alternative implementation, entries at locations within a predetermined portion of the media or predetermined portion of the addressing range (such as at the end of the addressing range) of the media may be interpreted as AtomicKeyTags instead of locations.

According to embodiments, during the transaction, any normal operations such as garbage collection, reads, and other management operation can proceed unaffected by the additional abstraction. If the operation requires use of the location, the Encoded AtomicKeyTag can be detected and the location information of either the original value or the pending value may be retrieved via the AtomicKeyTag as needed.

Note that at the time of generating the metadata update, which includes the encoded AtomicKeyTag, the pending Value data may not yet be written by the host (depending on AtomicKeyTag allocation method). According to embodiments, as the host writes the new Key-Value pair, which are part of the transaction, the host includes a reference to the transaction so the updates can be identified as part of the transaction. Should some other host attempt to update a Key that is part of a transaction, this can be detected using the AtomicKeyTag encoded in the location, or via the Duplicate Key Detector as discussed relative to FIG. 6. On detection, various behaviors are possible depending on API and system requirements, most likely aborting the transaction.

As shown in FIG. 13, as the host writes the new Key-Value pairs, the Atomic Metadata generated from the writes of the pending values may be temporarily stored in the AtomicKeyTag table 1302, which is indexed by AtomicKeyTag 902. Each entry in the AtomicKeyTag table 1302 indexed by the AtomicKeyTag 902 may include the AtomicTransactionTag to identify the multi-command transaction, the AtomicMetadata, which is the metadata of the PendingValue 1208 and the OriginalMetadata, which is the metadata of the OriginalValue 1206, to enable the system to back out of a transaction and restore original Value data and the corresponding metadata thereof should the command fail. Several entries in the AtomicKeyTag table 1302 may list the same AtomicTransactionTag 504.

As also shown in FIG. 13, the AtomicTransactionTag 504 is used to index into the AtomicTransactionTag Table 1304, which may include head and tail location pointers for the list of AtomicKeyTags 902 specified by the AtomicTransactionTag 504. The metadata of list of Keys that is written as the initial part of the transaction, ListMetadata, may also be tracked in the AtomicTransactionTag table 1304, along with a count of the AtomicKeyTags 902 corresponding to the UserKeys specified by the multi-command transaction identified by the AtomicTransactionTag 504.

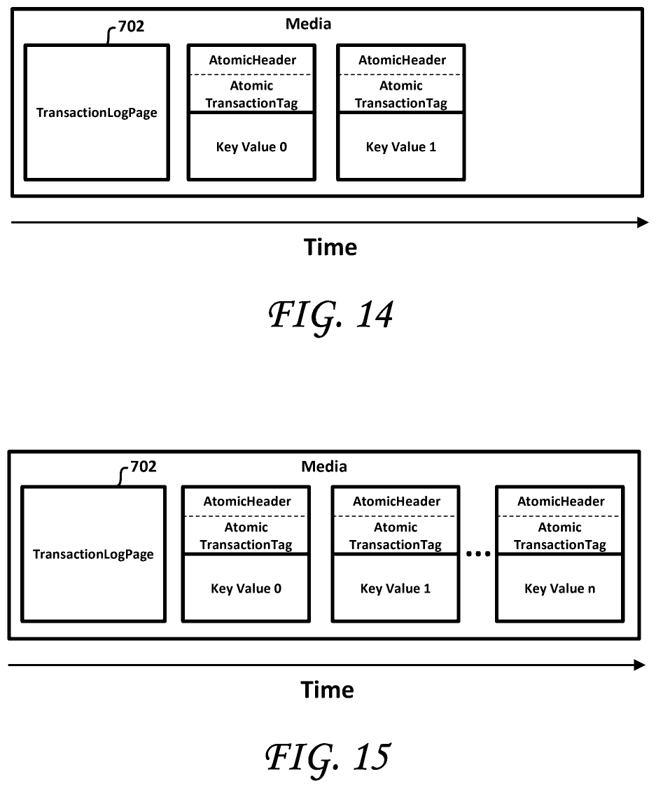

As the write operations of the various Keys arrive from the host, the Atomic Metadata updates may also be stored in the AtomicMetadata field in the AtomicKeyTag table 1302. The new key-Value data is written with an AtomicHeader in the media, which AtomicHeader includes a field for the AtomicTransactionTag. FIG. 14 shows the Media during execution of the multi-command transaction, after writing some (in this case, two) but not all of the Keys of the transaction.

If power fails at this point (i.e., before the Value data corresponding to all Keys of the transaction have been written), the TransactionLogPage 702 will be discovered and, as only two of the Keys are written, the Atomic Metadata corresponding to the writes of the two Keys will be discarded, such that the metadata mapping system no longer tracks the written Keys, as if they never existed. It may be necessary for management purposes to rewrite the TransactionLogPage. If this is necessary, the location information for any previously written Keys would also be saved.

Once all Keys are written, the transaction will be considered completed and the media will be in the state shown in FIG. 15, with updated Value data for each AtomicTransactionTag corresponding to each of the n UserKeys of the multi-command transaction having been executed.

According to embodiments, during power fail recovery, the difference between the partial transaction and completed transaction cases can be determined from the TransactionLogPage. Recall that the TransactionLogPage includes a Count of the AtomicTransactionTags. Therefore, the Count of the AtomicHeaders/Key Values present in the TransactionLogPage may be used to determine whether the transaction has failed/was only partially completed (FIG. 14) or has completed (FIG. 15). Any unwritten Atomic Metadata lost during a power cycle can be reconstructed for completed transactions or discarded for partial transactions.

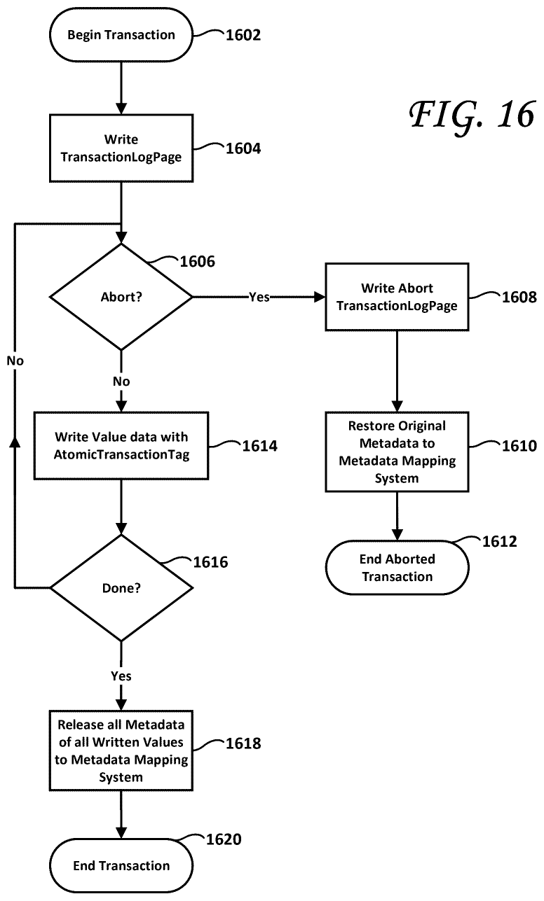

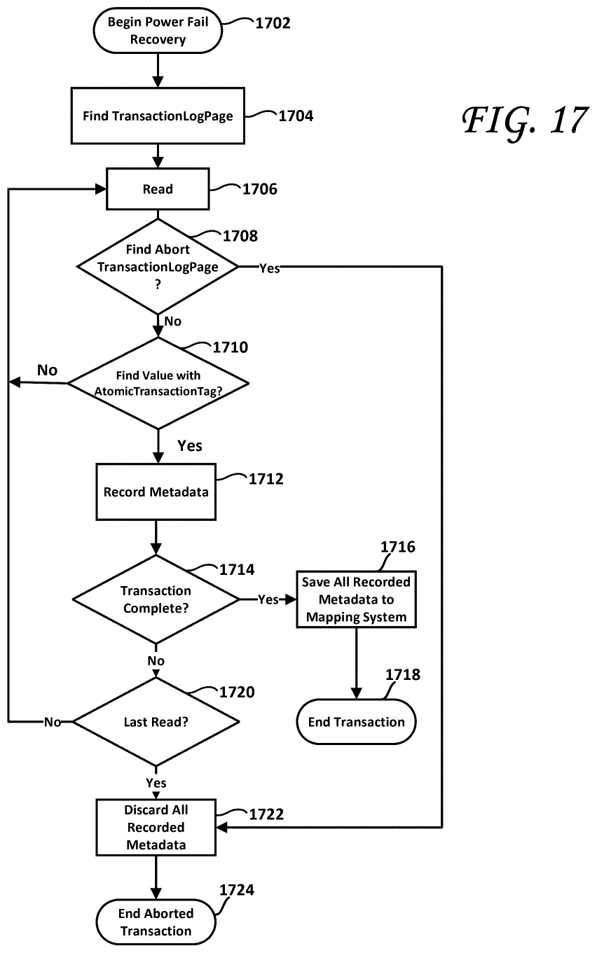

FIG. 16 is a flow chart of a computer-implemented method according to an embodiment, detailing steps taken for a completed multi-command transaction and an aborted transaction. As shown therein, a transaction may begin at 1602, whereupon a multi-command transaction may be received and a corresponding TransactionLogPage may be written, as shown at 1604. Recall that, as shown in FIGS. 7 and 8, the TransactionLogPage 702 includes the AtomicTransactionTag assigned to the list of Keys and each constituent UserKey and location of the List of Keys 504. At 1606 in FIG. 16, it is determined whether an Abort has occurred. If an Abort has indeed occurred a record of the Abort is made in an AbortTransactionLogPage, as shown at 1608. According to one embodiment, the AbortTransactionLogPage referred to at 1608 may have the same structure as the TransactionLogPage 702 of FIGS. 7 and 8, but for the presence of a different header that indicates that this TransactionLogPage is, in fact, an AbortTransactionLogPage. The AbortTransactionLogPage provides a persistent record of the failure of the underlying multi-command transaction. Continuing, after the writing of the AbortTransactionLogPage at 1608, the original metadata may be restored the metadata mapping system, as shown at 1610. Indeed, if a transaction is aborted, the Original Metadata (OriginalMetadata in FIG. 13) saved in the AtomicKeyTag table 1302 may be used to replace the AtomicKeyTag currently in the metadata management system. In practice, the restoration of the original metadata may not require an actual update, as the original metadata was not changed. However, implementation simplicity may recommend performing the update to media, even if the original metadata is replaced with the identical metadata (the Original Metadata) from the AtomicKeyTag table 1302. Regardless, as these sequences must be power-safe, a transaction log with failure indication (the AbortTransactionLogPage referred to at 1608) may be written to the media. The AbortTransactionLogPage allows for simplified detection of aborted transaction during power-fail recovery, as detailed relative to FIG. 17. In FIG. 16, after the original metadata has been restored following an abort, the end of the aborted transaction is reached at 1612.

If, however, no Abort is detected at 1606, the Value data associated with the first AtomicKeyTag 902 of the AtomicTransactionTag 504 may be written at 1614. At 1616, it may be determined whether the Value data of the last AtomicKeyTag 902 of the AtomicTransactionTag 504 has been written. If not, the flow reverts back to 1606, for a determination of whether an Abort has been detected and the writing of the next Value data associated with the next AtomicKeyTag 902 of the AtomicTransactionTag 504 (using the AtomicKeyTag 902 to index into an AtomicKeyTag table 1302, for example). After the last Value data has been written (“Yes” branch of 1616), the multi-command transaction is deemed to have completed and the Atomic Metadata associated with the written Value data may now be released to the metadata mapping system such that the metadata mapping system may be suitably updated, as shown at 1618. The transaction then ends at 1620.

FIG. 17 is a flowchart of a computer-implemented method of recovering original Value data and associated metadata, after a power fail abort has been detected, according to embodiments. The computer-implemented method begins at 1702. During power fail recovery, the media may be scanned for Value data for which the updated metadata (including metadata for non-Atomic transactions) has not yet been saved. During this process, a TransactionLogPage may be discovered, as shown at 1704 and read as shown at 1706. The TransactionLogPage will contain an AtomicTransactionTag corresponding to the multi-command transaction and a list of Keys. If the TransactionLogPage read at 1706 is determined to be an AbortTransactionLogPage at 1708, which indicates that the transaction associated with the AtomicTransactionTag did not complete successfully, then all recorded Atomic Metadata updates associated with that AtomicTransactionTag may be discarded at 1722 and the end of the process may be reached at 1724. If, however, the TransactionLogPage read at 1706 is determined to not be an AbortTransactionLogPage at 1708), it may next be determined whether a Value data with matching AtomicTransactionTag is found at 1710. If not, the method reverts back to 1706 to continue the read. It is to be noted that the “No” path of block 1710 will still handle unwritten metadata for non-transaction commands. If a new Value data is found with matching AtomicTransactionTag at 1710, the Atomic Metadata for the updated Value data, including without limitation the location and size information, may be recorded in a temporary location (such as the AtomicKeyTag table 1302) at 1712. If it is determined that the multi-command transaction is complete at 1714 (all Keys have been written with updated Value data for each AtomicTransactionTag corresponding to each UserKey, as shown in FIG. 15), then all recorded Atomic Metadata may be saved to the metadata mapping system as shown at 1716 and the method may end at 1718. If, however, the multi-commend transaction was not completed (“No” branch of 1714), it may be determined whether there are any further Value data to read that are not associated with updated Atomic Metadata. If not (“No” branch of 1720), the method may revert to 1706 whereupon the scanning for Value data continues. If, however, there are no more Value data with matching AtomicTransactionTag to read (“Yes” branch of 1720), then it may be determined that the transaction did not complete and all previously recorded Atomic Metadata associated with the TransactionLogPage may be discarded at 1722 and the method may end at 1724. However, as noted above, implementation simplicity may recommend performing an update to the metadata mapping system with the Original Metadata from the AtomicKeyTag table 1302 anyway. In this manner, the metadata mapping system is always suitably updated, whether or not the underlying multi-command transaction successfully completed or failed.

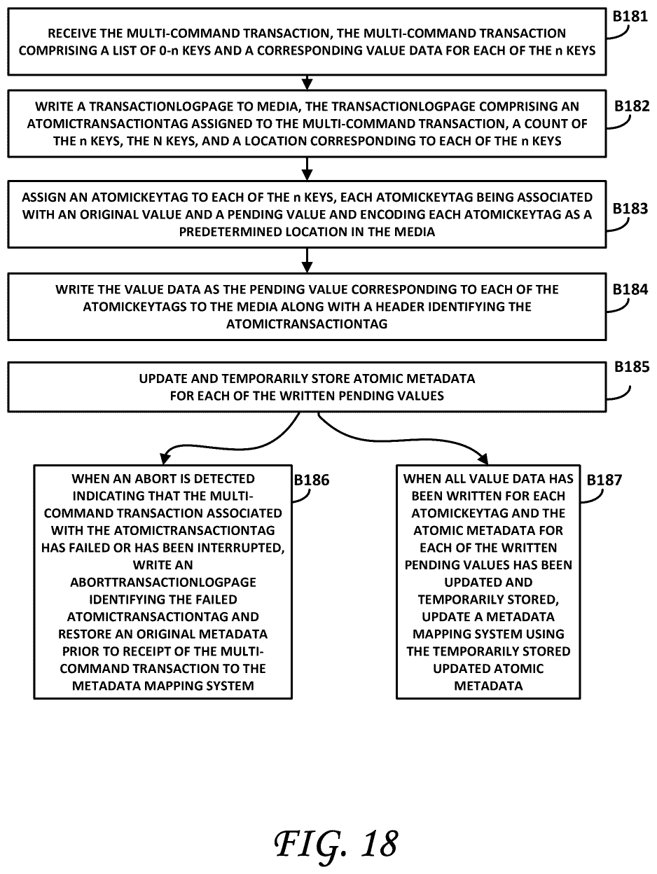

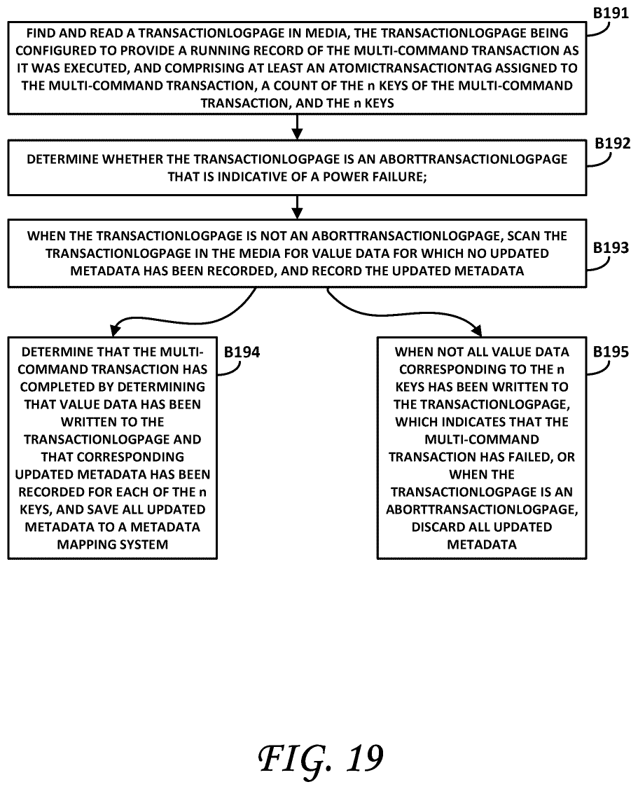

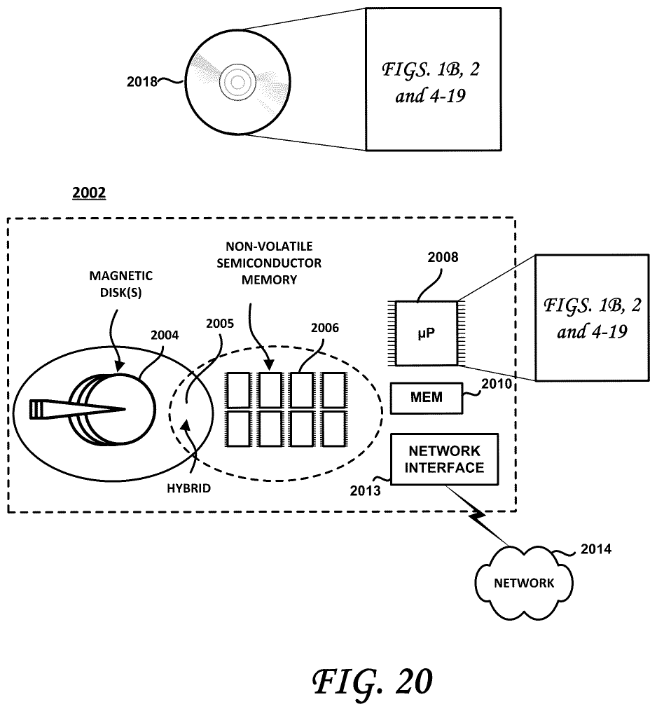

FIG. 18 is a flowchart of a computer-implemented method of implementing a multi-command transaction in a Key-Value store according to an embodiment. As shown therein, block B181 calls for receiving the multi-command transaction, the multi-command transaction comprising a list of 0-n Keys and separate commands and value data for each of the n keys. In block B182, a TransactionLogPage may be written to media, with the TransactionLogPage comprising an AtomicTransactionTag assigned to the multi-command transaction, a Count of the n Keys, the n Keys, and the Atomic Metadata corresponding to each of the n Keys, with the Atomic Metadata initially being invalid. As shown at B183, an AtomicKeyTag may then be assigned for each of the n Keys. According to an embodiment, each AtomicKeyTag may be associated with an original value and a pending value and each AtomicKeyTag may be encoded as a predetermined location in the media. In B184, a command may be received and executed corresponding to each of the n Keys to write the Value data as the pending value corresponding to each of the AtomicKeyTags to the media along with a header identifying the AtomicTransactionTag. B185 calls for updating and temporarily storing the Atomic Metadata for each of the written pending values.

Thereafter, the actions and functionalities of either block B186 or block B187 may be performed and enabled. As shown at B186, when an Abort is detected indicating that the multi-command transaction associated with the AtomicTransactionTag has failed or has been interrupted, the computer-implemented method may further comprise rewriting the TransactionLogPage as an AbortTransactionLogPage (by changing a header thereof, for example) identifying the failed AtomicTransactionTag and restoring an original metadata prior to receipt of the multi-command transaction to the metadata mapping system. Alternatively and as shown at B187, when all Value data has been written for each AtomicKeyTag and the Atomic Metadata for each of the written pending values has been updated and temporarily stored, the computer-implemented method may further comprise updating the metadata mapping system using the temporarily stored updated Atomic Metadata.
1. According to further embodiments, the metadata mapping system may be enabled to manage both the original value and the pending value using a single AtomicKeyTag that is interpreted as a location within the media. Alternatively, the metadata mapping system may be configured to manage both the original value and the pending value using one of a flag, a unique metadata configuration and an illegal metadata configurations to refer to at least one of the AtomicKeyTags. A duplicate key detection may be carried out for each of the received n keys prior to writing the TransactionLogPage to the media and the multi-command transaction may be if a duplicate key is detected. According to one embodiment, updating and temporarily storing may further comprise writing atomic metadata generated from the writes of the pending values in an AtomicKeyTag table that is indexed by the AtomicKeyTag of each of the n keys, the AtomicKeyTag table comprising atomic metadata of the written pending value and original metadata of the original value. Restoring the original metadata prior to receipt of the multi-command transaction to the metadata mapping system may comprise accessing the original metadata of the original value stored in the AtomicKeyTag table for the AtomicKeyTag of each of the n keys of the multi-command transaction. Updating the metadata mapping system may comprise accessing the atomic metadata of the written pending value stored in the AtomicKeyTag table for the AtomicKeyTag of each of the n keys of the multi-command transaction. The pending value may be initially invalid before the value data is written as the pending value. The computer-implemented method may further comprise writing the value data for each AtomicKeyTag in turn to the TransactionLogPage. Rewriting the TransactionLogPage as the AbortTransactionLogPage may comprise, in one implementation, modifying a header of the TransactionLogPage to indicate that the TransactionLogPage is an AbortTransactionLogPage. The method may further comprise rewriting the TransactionLogPage as the AbortTransactionLogPage when the multi-command transaction does not complete, only partially completes or upon occurrence of a predetermined system event.

Another embodiment is a Key-Value data store configured to implement a multi-command transaction, comprising: a storage device, the storage device being configured to store and enable access to user data via a key-value system; a memory; at least one processor, and a plurality of processes spawned by the processor. The plurality of processes may comprise processing logic to receive the multi-command transaction, the multi-command transaction comprising a list of 0-n keys and separate commands and value data for each of the n keys; write a TransactionLogPage to media, the TransactionLogPage comprising an AtomicTransactionTag assigned to the multi-command transaction, a count of the n keys, the n keys, and atomic metadata corresponding to each of the n keys; assign an AtomicKeyTag to each of the n keys, each AtomicKeyTag being associated with an original value and a pending value and encode each AtomicKeyTag as a predetermined location in the media; receive and execute a command corresponding to each of the n keys to write the value data as the pending value corresponding to each of the AtomicKeyTags to the media along with a header identifying the AtomicTransactionTag; update and temporarily store an atomic metadata for each of the written pending values, and one of: when an Abort is detected indicating that the multi-command transaction associated with the AtomicTransactionTag has failed or has been interrupted, rewrite the TransactionLogPage as an AbortTransactionLogPage that identifies the failed AtomicTransactionTag and restore an original metadata prior to receipt of the multi-command transaction to the metadata mapping system; when all value data has been written for each AtomicKeyTag and the atomic metadata for each of the written pending values has been updated and temporarily stored, update a metadata mapping system using the temporarily stored updated atomic metadata in the memory.

As shown in FIG. 19, another embodiment is a computer-implemented method of recovering from a power failure in a Key-Value store implementing a multi-command transaction. Such a method may comprise, as shown at B191, finding, and reading a TransactionLogPage in media, the TransactionLogPage being configured to provide a running record of the multi-command transaction as the multi-command transaction was executed. The TransactionLogPage may comprise at least an AtomicTransactionTag assigned to the multi-command transaction, a count of the n keys of the multi-command transaction, and the n keys. At B192, it may be determined whether or not the TransactionLogPage is an AbortTransactionLogPage that is indicative of a failure of an execution of the milt-command transaction. When the TransactionLogPage is not an AbortTransactionLogPage, the TransactionLogPage in the media may be scanned for value data for which no updated Atomic metadata has been recorded. If such value data for which no Atomic Metadata was recorded is found, the Atomic Metadata thereof may be recorded, as shown at B193.

Thereafter, according to an embodiment, either block B194 or B195 may be carried out. As shown at B194, it may then be determined that the multi-command transaction has been completed by determining that, for each of the n keys, Value data has been written to the TransactionLogPage and corresponding updated Atomic Metadata has been recorded. All saved and updated Atomic metadata may then be saved to the metadata mapping system. Alternatively, as shown at B195, when not all value data corresponding to the n keys has been written to the TransactionLogPage, which indicates that the multi-command transaction has failed (for whatever reason), or when the TransactionLogPage is an AbortTransactionLogPage, all updated Atomic Metadata may be discarded.
2. According to further embodiments, an AtomicKeyTag may be assigned for each of the n keys, each AtomicKeyTag being associated with an original value and a pending value and each AtomicKeyTag is encoded as a predetermined location in the media. Alternatively, an AtomicKeyTag may be assigned to each of the n keys and each AtomicKeyTag being associated with an original value and a pending value and the computer-implemented method may further comprise configuring the metadata mapping system to manage both the original value and the pending value using a flag, a unique metadata configuration or an illegal metadata configuration to refer to at least one of the AtomicKeyTags. Recording the updated Atomic Metadata may include writing the updated Atomic Metadata in an AtomicKeyTag table that is indexed by the AtomicKeyTag of each of the n keys. The AtomicKeyTag table may include Original Metadata of an original value data prior to the multi-command transaction and Atomic Metadata of the written Value data.

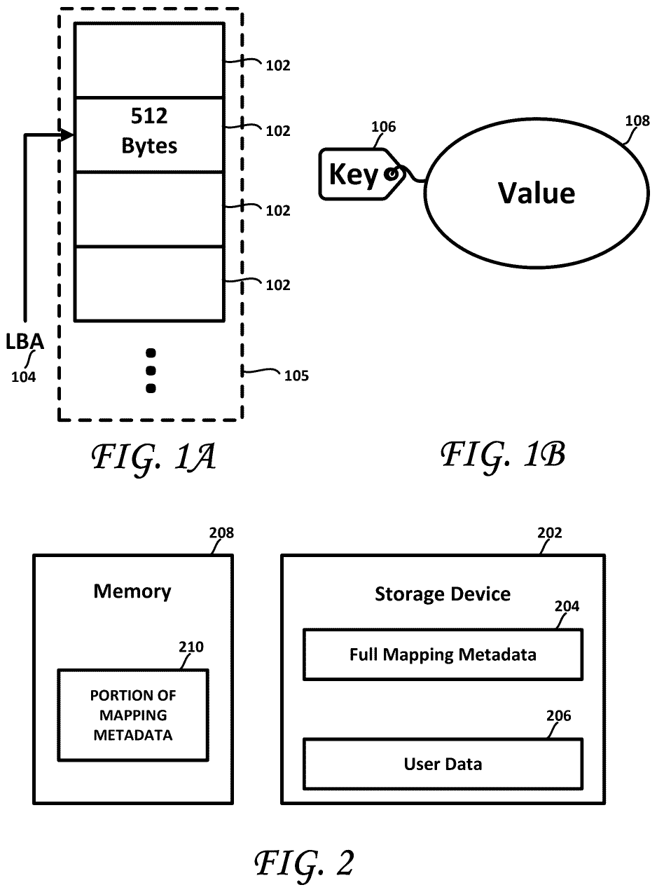

FIG. 20 a computer system configured to execute the computer-implemented methods shown and described herein. According to one embodiment, the computer system may comprise at least storage media 2004, 2005, 2006, at least one processor 2008, memory 2010 and a network interface 2013. A plurality of processes may be spawned by the processor 2008, which plurality of processes may comprise processing logic to carry out the computer-implemented methods and functionality shown and described at least relative to FIGS. 1B, 2 and 4-19. FIG. 20 also shows exemplary tangible, non-transitory computer-readable media 2018 having data stored thereon representing sequences of instructions which, when executed by the computer system, cause the computer system to carry out a computer-implemented method of implementing a multi-command transaction in a Key-Value store and a computer-implemented method of recovering from a power failure in a Key-Value store implementing a multi-command transaction according to one or more of the embodiments described herein.

Discussing now FIG. 20 in greater detail, the computer system may comprise direct access data storage devices such as magnetic disks 2004, non-volatile semiconductor memories (EEPROM, Flash, etc.) 2006, a hybrid data storage device 2005 comprising both magnetic disks 2004 and non-volatile semiconductor memories, one or more microprocessors 2008 and volatile memory 2010. The computer system may also comprise a network interface 2013, configured to communicate over network 2014 with remote servers, storage services and the like. References 2004, 2005, 2006 and 2018 are examples of tangible, non-transitory computer-readable media having data stored thereon representing sequences of instructions or processing logic which, when executed by the computer system, cause the computer system to carry out the computer implemented methods described herein and shown at least relative to FIGS. 1B, 2 and 4-19. Some of these instructions may be stored locally in the computer system 2002, while others of these instructions may be stored (and/or executed) remotely and communicated to the computer system 2002 over the network 2014. In other embodiments, all these instructions may be stored locally in the computer system 2002, while in still other embodiments, all of these instructions are stored and executed remotely, and the results communicated to the computer system 2002. In another embodiment, the instructions may be stored on another form of a tangible, non-transitory computer readable medium, such as shown at 2018. For example, reference 2018 may be implemented as an optical or magnetic disk, which may constitute a suitable data carrier to load the instructions stored thereon onto the computer system 2002, thereby re-configuring the computer system to one or more of the embodiments described and shown herein.

In the foregoing description, numerous specific details are set forth in order to provide a thorough understanding of one or more aspects and/or features of the exemplary embodiments. It will be apparent to one skilled in the art, however, that one or more aspects and/or features described herein may be omitted in favor of others or omitted all together. Herein, each described and/or shown important feature, structure or functionality can be isolated from the others. Thus, individual aspects, features, structures described in relation to one embodiment may be used in, added to, or substituted in in relation to another embodiment. In some instances, the description of well-known process steps and/or structures are omitted for clarity or for the sake of brevity.

Herein, devices or processes that are described as being in communication with each other need not be in continuous communication with each other, unless expressly specified otherwise. In addition, devices or processes that are disclosed to be in communication with one another may communicate directly or indirectly through one or more intermediaries.

Further, although constituent steps of methods have been described in a sequential order, such methods may be configured to work in alternate orders. In other words, any sequence or order of steps that may be described herein does not, in and of itself, indicate a requirement that the steps be performed in that order. The steps of described processes may be performed in an order that differs from the order described herein. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred over other processes.

When a single device or article is described, it will be readily apparent that more than one device/article (e.g., whether or not they cooperate) may be used in place of a single device/article. Similarly, where more than one device or article is described (e.g., whether or not they cooperate), it will be readily apparent that a single device/article may be used in place of the more than one device or article. The functionality and/or the features of a device may be alternatively embodied by one or more other devices that are not explicitly described as having such functionality/features.

Lastly, while certain embodiments of the disclosure have been described, these embodiments have been presented by way of example only and are not intended to limit the scope of the disclosure. Indeed, the novel methods, devices and systems described herein may be embodied in a variety of other forms. Furthermore, various omissions, substitutions, and changes in the form of the methods and systems described herein may be made without departing from the spirit of the disclosure. The accompanying claims and their equivalents are intended to cover such forms or modifications as would fall within the scope and spirit of the disclosure. For example, those skilled in the art will appreciate that in various embodiments, the actual physical and logical structures may differ from those shown in the figures. Depending on the embodiment, certain steps described in the example above may be removed, others may be added. Also, the features and attributes of the specific embodiments disclosed above may be combined in different ways to form additional embodiments, all of which fall within the scope of the present disclosure. Although the present disclosure provides certain preferred embodiments and applications, other embodiments that are apparent to those of ordinary skill in the art, including embodiments which do not provide all the features and advantages set forth herein, are also within the scope of this disclosure. Accordingly, the scope of the present disclosure is intended to be defined only by reference to the appended claims.

1. A computer-implemented method of implementing a multi-command transaction in a key-value store, the computer-implemented method comprising:
receiving the multi-command transaction, the multi-command transaction comprising a list of 0-n keys and separate commands and value data for each of the n keys;
writing a TransactionLogPage to media, the TransactionLogPage comprising an AtomicTransactionTag assigned to the multi-command transaction, a count of the n keys, the n keys, and atomic metadata corresponding to each of the n keys;
assigning an AtomicKeyTag to each of the n keys, each AtomicKeyTag being associated with an original value and a pending value and encoding each AtomicKeyTag as a predetermined location in the media;
receiving and executing a command corresponding to each of the n keys to write the value data as the pending value corresponding to each of the AtomicKeyTags to the media along with a header identifying the AtomicTransactionTag;
updating and temporarily storing an atomic metadata for each of the written pending values, and one of:
when an Abort is detected indicating that the multi-command transaction associated with the AtomicTransactionTag has failed or has been interrupted, rewriting the TransactionLogPage as an AbortTransactionLogPage that identifies the failed AtomicTransactionTag and restoring an original metadata prior to receipt of the multi-command transaction to the metadata mapping system;
when all value data has been written for each AtomicKeyTag and the atomic metadata for each of the written pending values has been updated and temporarily stored, updating a metadata mapping system using the temporarily stored updated atomic metadata.

2. The computer-implemented method of claim 1, further comprising enabling the metadata mapping system to manage both the original value and the pending value using one of a flag, a unique metadata configuration and an illegal metadata configurations to refer to at least one of the AtomicKeyTags.

3. The computer-implemented method of claim 1, further carrying out a duplicate key detection for each of the received n keys prior to writing the TransactionLogPage to the media and aborting the multi-command transaction if a duplicate key is detected.

4. The computer-implemented method of claim 1, wherein updating and temporarily storing further comprises writing atomic metadata generated from the writes of the pending values in an AtomicKeyTag table that is indexed by the AtomicKeyTag of each of the n keys, the AtomicKeyTag table comprising atomic metadata of the written pending value and original metadata of the original value.

5. The computer-implemented method of claim 4, wherein restoring the original metadata prior to receipt of the multi-command transaction to the metadata mapping system comprises accessing the original metadata of the original value stored in the AtomicKeyTag table for the AtomicKeyTag of each of the n keys of the multi-command transaction.

6. The computer-implemented method of claim 4, wherein updating a metadata mapping system comprises accessing the atomic metadata of the written pending value stored in the AtomicKeyTag table for the AtomicKeyTag of each of the n keys of the multi-command transaction.

7. The computer-implemented method of claim 1, wherein the pending value is initially invalid before the value data is written as the pending value.

8. The computer-implemented method of claim 1, further comprising writing the value data for each AtomicKeyTag in turn to the TransactionLogPage.

9. The computer-implemented method of claim 1, wherein rewriting the TransactionLogPage as the AbortTransactionLogPage comprises modifying a header of the TransactionLogPage to indicate that the TransactionLogPage is an AbortTransactionLogPage.

10. The computer-implemented method of claim 9, further comprising rewriting the TransactionLogPage as the AbortTransactionLogPage when the multi-command transaction does not complete, only partially completes or upon occurrence of a predetermined system event.

11. A Key-Value data store configured to implement a multi-command transaction, comprising:
a storage device, the storage device being configured to store and enable access to user data via a key-value system;
a memory;
at least one processor;
a plurality of processes spawned by the processor, the plurality of processes comprising processing logic to:
receive the multi-command transaction, the multi-command transaction comprising a list of 0-n keys and separate commands and value data for each of the n keys;
write a TransactionLogPage to media, the TransactionLogPage comprising an AtomicTransactionTag assigned to the multi-command transaction, a count of the n keys, the n keys, and atomic metadata corresponding to each of the n keys;
assign an AtomicKeyTag to each of the n keys, each AtomicKeyTag being associated with an original value and a pending value and encode each AtomicKeyTag as a predetermined location in the media;
receive and execute a command corresponding to each of the n keys to write the value data as the pending value corresponding to each of the AtomicKeyTags to the media along with a header identifying the AtomicTransactionTag;
update and temporarily store an atomic metadata for each of the written pending values, and one of:
when an Abort is detected indicating that the multi-command transaction associated with the AtomicTransactionTag has failed or has been interrupted, rewrite the TransactionLogPage as an AbortTransactionLogPage that identifies the failed AtomicTransactionTag and restore an original metadata prior to receipt of the multi-command transaction to the metadata mapping system;
when all value data has been written for each AtomicKeyTag and the atomic metadata for each of the written pending values has been updated and temporarily stored, update a metadata mapping system using the temporarily stored updated atomic metadata in the memory.

12. The Key-Value data store of claim 11, further comprising processing logic to enable the metadata mapping system to manage both the original value and the pending value using one of a flag, a unique metadata configuration and an illegal metadata configurations to refer to at least one of the AtomicKeyTags.

13. The Key-Value data store of claim 11, further comprising processing logic to carry out a duplicate key detection for each of the received n keys prior to writing the TransactionLogPage to the storage device and to abort the multi-command transaction when a duplicate key is detected.

14. The Key-Value data store of claim 11, wherein the processing logic for updating and temporarily storing further comprises processing logic to write atomic metadata generated from the writes of the pending values in an AtomicKeyTag table that is indexed by the AtomicKeyTag of each of the n keys, the AtomicKeyTag table comprising atomic metadata of the written pending value and original metadata of the original value.

15. The Key-Value data store of claim 14, wherein the processing logic for restoring the original metadata prior to receipt of the multi-command transaction to the metadata mapping system comprises processing logic for accessing the original metadata of the original value stored in the AtomicKeyTag table for the AtomicKeyTag of each of the n keys of the multi-command transaction.

16. The Key-Value data store of claim 14, wherein the processing logic for updating a metadata mapping system comprises processing logic for accessing the atomic metadata of the written pending value stored in the AtomicKeyTag table for the AtomicKeyTag of each of the n keys of the multi-command transaction.

17. The Key-Value data store of claim 11, wherein the pending value is initially invalid before the value data is written as the pending value.

18. The Key-Value data store of claim 11, wherein the processing logic for rewriting the TransactionLogPage as the AbortTransactionLogPage comprises processing logic for modifying a header of the TransactionLogPage to indicate that the TransactionLogPage is an AbortTransactionLogPage.

19. The Key-Value data store of claim 11, further comprising processing logic for writing the value data for each AtomicKeyTag in turn to the TransactionLogPage.

20. The Key-Value data store of claim 11, further comprising processing logic for rewriting the TransactionLogPage as the AbortTransactionLogPage when the multi-command transaction does not complete, only partially completes or upon occurrence of a predetermined system event.

21. A computer-implemented method of recovering from a power failure in a Key-Value store implementing a multi-command transaction, the computer-implemented method comprising:
finding and reading a TransactionLogPage in media, the TransactionLogPage being configured to provide a running record of the multi-command transaction as the multi-command transaction was executed, the TransactionLogPage comprising at least an AtomicTransactionTag assigned to the multi-command transaction, a count of the n keys of the multi-command transaction, and the n keys;
determining whether the TransactionLogPage is an AbortTransactionLogPage that is indicative a failure of an execution of the multi-command transaction;
when the TransactionLogPage is not an AbortTransactionLogPage, scanning the TransactionLogPage in the media for value data for which no updated atomic metadata has been recorded, and recording the updated atomic metadata, and
carrying out one of:
determining that the multi-command transaction has completed by determining that, for each of the n keys, value data has been written to the TransactionLogPage and corresponding updated atomic metadata has been recorded, and saving all updated atomic metadata to a metadata mapping system;
when not all value data corresponding to the n keys has been written to the TransactionLogPage, which indicates that the multi-command transaction has failed, or when the TransactionLogPage is an AbortTransactionLogPage, discarding all updated atomic metadata.

22. A computer-implemented method of claim 19, wherein an AtomicKeyTag is assigned to each of the n keys, each AtomicKeyTag being associated with an original value and a pending value and wherein the computer-implemented method further comprises configuring the metadata mapping system to manage both the original value and the pending value using one of a flag, a unique metadata configuration and an illegal metadata configurations to refer to at least one of the AtomicKeyTags.

23. A computer-implemented method of claim 19, wherein recording the updated atomic metadata comprises writing the updated atomic metadata in an AtomicKeyTag table that is indexed by the AtomicKeyTag of each of the n keys, the AtomicKeyTag table comprising original metadata of an original value data prior to the multi-command transaction and atomic metadata of the written value data.
